(19) United States
(12) Patent Application Publication
(10) Pub. No.: US 2020/0101788 A1
(43) Pub. Date: Apr. 2, 2020

(54) METHOD AND APPARATUS FOR HAND-REPLICATING EMBOSSED METAL ARTWORK

(71) Applicant: Junji John SHIMAZAKI, Sterling, VA (US)

(72) Inventor: Junji John SHIMAZAKI, Sterling, VA (US)

(21) Appl. No.: 16/566,740

(22) Filed: Sep. 10, 2019

Related U.S. Application Data
(60) Provisional application No. 62/737,485, filed on Sep. 27, 2018.

(51) Int. Cl. B44B 5/00; B44B 5/02

(52) U.S. Cl. CPC B44B 5/0052; B44B 5/026

(57) ABSTRACT

The invention is a method and apparatus for hand-replicating original embossed metal artwork by transferring the three dimensional image of the original design onto one or more molds, including in the preferred embodiment, two molds—one having a positive image of the embossed design, and the other having a negative image—wherein they can be used sequentially, one after the other, to hand-craft and recreate the original design onto additional metal sheets and thus create multiple replicas of the original.

### RELATED APPLICATIONS

This application claims the benefit of U.S. Provisional Application Ser. No. 62/737,485, filed on Sep. 27, 2018, which is incorporated herein by reference in its entirety.

### FIELD OF THE INVENTION

This application relates to the field of artwork and in particular replicating original embossed metal artwork.

### BACKGROUND OF THE INVENTION

Embossed metal artwork typically comprises metal sheets that have been hand-worked to create raised and depressed lines and textures to create a three dimensional image of the artwork. This is normally done using hand tools or utensils to apply pressure onto the metal sheet, from both the front and back sides, with a padded surface underneath, to deform the sheet and create the embossed metal images of the artwork thereon.

The artist normally begins with a blank metal sheet and uses various hand tools or utensils, including those made of wood or other non-abrasive material, with varying widths and points, to form various images having varying depths, patterns, and configurations, etc., wherein artistic skill is typically required due to the need to form varying depths, textures, lines and patterns. And because of the three-dimensional nature of the finished artwork, the artist typically has to apply varying degrees of pressure from both sides of the sheet, depending on whether the image is raised or depressed, wherein typically, the artist has to work the sheet back and forth in this manner multiple times to achieve the desired results.

An original work of art normally takes a significant amount of time and effort to create. And because there's only one original—thus its name—the artist is only able to sell one copy, unless he/she can replicate it.

When there is sufficient demand for an original work of art, such as an original oil painting, the artist can make replicas of the original, such as with lithographs or serigraphs, and thus, multiple copies can be made available for the consumer art market. A variety of methods and techniques can be employed, to re-create the original, including those that are automated or partially done by hand, wherein the replicas can then be produced quickly and economically.

An example of a technique partially done by hand is a serigraph. When serigraphs are used to recreate an original oil painting, for example, the artist is required to hand-craft different layers on a silk screen, wherein each layer represents a particular color to be printed, and then by repeating these steps for each color in the painting, each color can be applied, one at a time, onto the canvas, wherein by silk screening each layer of color, one on top of the other, and repeating this process multiple times (as many times as there are colors in the finished piece), the overall image of the artwork can be recreated and multiple copies can be produced.

Although automated methods are also available to reproduce copies in higher volumes and at lower costs, such as standard printing, the advantage of serigraphs is that the artwork is in many respects made by hand, which requires significant skill to complete. Thus, given that each serigraph is, in part, an original work of art, the artist can normally create a limited edition series comprising multiple copies signed by the artist, offered to the consumer art market.

The amount of time it takes an artist to produce each original embossed metal artwork will depend on the complexity and size of the design, as well as the malleability of the metal, and other factors, etc. But because of the competitive nature of the consumer art market, a need exists to develop a method of producing hand-crafted replicas of the original, so that the cost of producing each piece can be reduced and thus the embossed metal artwork can be made available to the consumer art market at a relatively low cost.

### SUMMARY OF THE INVENTION

The present invention relates to a method and apparatus for hand-replicating original embossed metal artwork by transferring the three dimensional image of the original design onto one or more molds, including in the preferred embodiment, two molds—one having a positive image of the embossed design, and the other having a negative image—wherein they can be used sequentially, one after the other, to hand-craft and recreate the original design onto additional metal sheets and thus create multiple replicas of the original.

The first step comprises creating the original embossed metal artwork on a metal sheet that has been specially sized and designed for creating the mold(s). This can be done, for example, by using conventional embossing tools or utensil and techniques known in the art.

Preferably, the outer dimensions of the original metal sheet are larger than the size of the embossed design, with a border around it, so that multiple markers, such as X's, or +'s, or markers of any shape, including those protruding from one side of the metal sheet, and those protruding from the opposite side thereof, can be formed on the border around the periphery of the embossed design. These markers are either raised (convex) or depressed (concave) on the surface of the metal sheet, such as in alternating fashion, and are designed to be transferred onto the molds, in both the negative and positive images. Note that these markers are preferably used in subsequent steps to help align the embossed image formed on the mold with the embossed image formed on the metal sheets, as will be described in more detail below.

The original metal sheet is also preferably large enough so that it extends beyond the border periphery so that all four sides of extra material can be folded up, at right angles, to form a box-like structure, which can serve as the casting mold for the new molds. Preferably, the original metal sheet is at least two to six inches larger in overall dimension than the opening of the frame or mat board on which the finished artwork is to be mounted. That way, enough extra material exists on each side so that, when the sides are folded up, they can form side walls that are extended high enough—about one to three inches above the bottom surface of the box-like structure—to contain the resin material needed to create the new molds. This helps to form a five-sided container, open at the top, into which the resin can be poured.

To form the first mold, the first box-like container (hereinafter “first box structure”) is created by folding up the four side walls, with the positive image of the embossed design facing up, i.e., in the same direction. Care should be taken to fold up the sides, so that none of the artwork that has been created on the original metal sheet is disturbed or adversely affected.

Once the first box structure has been formed, a release agent, such as containing silicon or wax, is preferably applied to the inside surface, i.e., before the liquid resin mixture is poured, to enable easy removal of the mold afterwards. Then, the liquid resin, which can be made of epoxy or urethane, or other material, is preferably combined with a hardening catalyst, and poured into the first box structure, wherein after pouring, the mixture is allowed to set and cure for a predetermined amount of time. Preferably, enough resin mixture is poured into each mold, so that each mold is sufficiently thick, such as at least ½ inch, depending on the size of the mold, and so that it is strong and resists bending and cracking, etc. The liquid resin can be any known type that achieves the desired results, including those made of epoxy or urethane, which has sufficient strength and compression properties, including resistance to bending, etc.

Because the first box structure has a positive image of the embossed design facing up on the bottom surface thereof, once the mixture hardens, and the first mold is completed, it will form a rigid three dimensional negative image of the embossed design (which is a mirror image of the positive image) thereon. That is, the positive image of the design on the original metal sheet will be transferred to create a negative image of the same design on the first mold.

After the first mold is created, the same metal sheet that was used to create the first mold is preferably used to create the second mold, but this time, the same four side walls are folded in the opposite direction, backwards, so that this creates a second box structure with the negative image of the embossed design facing up on the bottom surface thereof. This can be done, for example, by carefully folding the four side walls in the opposite direction, and peeling away the bottom surface thereof, thereby removing the original metal sheet from the first mold, and in this manner, the same original metal sheet used to create the first box structure can be used to create the second box structure. But this time, the negative image of the embossed design (rather than the positive image) faces up in the same direction as the side walls.

Once the second box structure is created, the same release agent is preferably applied to the inside surface of the second box structure. Then, the same resin used to create the first mold is preferably mixed with the same hardening agent and poured into the second box structure, with its negative image of the embossed design facing up.

Because the second box structure has a negative image of the embossed design facing up on the bottom surface thereof, once the mixture hardens, and the second mold is completed, it will form a rigid three dimensional positive image of the embossed design (which is a mirror image of the negative image) thereon. That is, the negative image on the second box structure will be transferred to create a positive image of the same design on the second mold.

In creating the first and second molds, the markers that were created on the original metal sheet will be transferred onto the two molds, so that they are positioned on the border around the periphery of the embossed design. Preferably, some markers are raised on one side and other markers, such as in alternating fashion, will be raised on the opposite side, such that when they are transferred onto the molds, they form alternating raised and depressed markers positioned around the periphery of the embossed design on the two molds.

The two molds are then used to transfer and replicate the embossed design from the molds onto other metal sheets, hereinafter referred to as “new metal sheets” to create the replicas. Preferably, a press is used that can be hand operated, such as an arbor or hydraulic press, which can be any conventional type, including mechanical or electrical presses, etc., capable of applying enough pressure to deform and create the necessary details.

Preferably, each press step is performed and operated in the following manner:

First, a compressible pad, such as made of rubber, or other flexible material, is positioned at the bottom of the press, on top of a flat support plate. The compressible pad is preferably a flat slab of rubber that has sufficient density, thickness (such as one inch thick) and flexibility (hardness durometer) which enables the new metal sheet to be deformed properly. For example, the compressible pad must be hard enough to resist the pressure that can be applied by the press to deform the new metal sheet, but soft enough to fill the cracks and crevices on the mold to replicate sufficient detail in the finished artwork.

A new metal sheet is then positioned on top of the compressible pad so that it lays flat and its bottom surface is positioned adjacent the compressible pad and preferably centered thereon.

The new metal sheet is preferably larger than the size of the opening of the frame/mat board upon which it is to be mounted, and large enough so that multiple markers can be formed on the new metal sheet, although the new metal sheet does not have to be as large as the original metal sheet. The new metal sheet is preferably made of 36 or 38 gauge aluminum, although not necessarily so, and is sufficiently stiff to hold its shape, although pliable enough so that sufficient detail can be transferred using pressure applied by the press.

The first mold is then positioned on top of the new metal sheet, with the negative image of the embossed design facing down, so that it rests on top of the new metal sheet. A rigid upper plate, such as made of metal or steel that resists bending, which is larger than the size of the first mold, is preferably positioned on top of the first mold to protect it from bending and cracking. This helps to ensure that little or no bending forces are acted upon the first mold, wherein the rigid plate prevents the first mold from cracking and breaking, etc.

With the new metal sheet positioned between the compressible pad and the first mold, sufficient pressure is applied by the press, wherein the pressure is transferred onto the rigid upper plate and then onto the first mold, which compresses the new metal sheet between the first mold and the compressible pad, and thus, the embossed design and its details are transferred. Because the negative image of the embossed design faces down, when the press is operated, the new metal sheet will be deformed upward, into the negative spaces formed by the first mold, to create the embossed design.

Once most of the image of the embossed design has been transferred onto the new metal sheet, pressure is released and the press is raised, after which the first mold and the new metal sheet are removed from the press. Then, the second mold is preferably positioned on the opposite side of the new metal sheet, opposite the first mold, wherein the four side walls extending from the new metal sheet are preferably folded backward and wrapped around the second mold, thus releasing the first mold from the new metal sheet, and enabling a better transfer, all the while keeping the embossed design accurately positioned on the second mold.

At this point, it is important to note that before the next press step is performed using the second mold, the negative image of the embossed design formed on the new metal sheet will need to be aligned with the positive image of the embossed design on the second mold, so that accurate transfer of the embossed design to the new metal sheet can continue during the second press step, wherein the second mold is used to deepen and enhance the details of the embossed design thereon. In this respect, because two molds are used—one having a positive image of the embossed design, and the other having a negative image—it is important that the negative and positive images are aligned properly between the first and second press steps, using the first and second molds, to accurately transfer details onto the new metal sheet.

Accordingly, once the artist performs the first step using the first mold and creates the embossed design on the new metal sheet, the artist preferably uses the markers on the new metal sheet and aligns them with the markers on the second mold, and uses them to align the negative image of the embossed design that has been formed on the new metal sheet with the positive image of the embossed design on the second mold, prior to operating the second press step. That is, the artist feels the alternating raised and depressed markers on the new metal sheet and aligns them with the depressed and raised markers on the second mold, wherein they mate together to keep the new metal sheet in position relative to the second mold. This helps to ensure that the second mold is properly aligned with the new metal sheet to transfer its details into the new metal sheet, i.e., the positive image of the embossed design on the second mold will be further transferred into the negative image formed on the new metal sheet.

Once the proper alignments have been made, the second mold, with the new metal sheet positioned against it, is preferably placed on top of the compressible pad, with the positive image of the embossed design on the second mold facing down against the negative image of the embossed design formed on the new metal sheet facing up. The same upper rigid plate is then placed on top of the second mold to protect the second mold from bending and cracking.

With the new metal sheet positioned between the compressible pad and the second mold, the stack is now ready to be compressed using the press. Sufficient pressure is preferably applied by the operator so that pressure is applied onto the rigid upper plate and then onto the second mold, wherein the new metal sheet is compressed between the second mold and the compressible pad, and thus, the additional details of the embossed design are transferred onto the new metal sheet. Because the positive image of the embossed design on the second mold faces down, and the negative image on the new metal sheet faces up, when the press is operated, further details of the embossed design will be transferred onto the new metal sheet.

Once the embossed design has been further transferred onto the new metal sheet, pressure is released and the press is raised, after which the second mold and the new metal sheet are removed from the press, wherein, the finished new metal sheet is separated from the second mold, thus completing the replica of the original design.

The invention also preferably comprises the following:

Creating the original artwork on an original metal sheet having predetermined dimensions and creating the embossing of the original artwork using hand tools with a foam pad underneath;

Creating a border around the embossed design sufficient in width to secure the artwork to a frame or mat board and creating multiple markers on the outside half of the border;

Creating multiple markers in the shape of x's or +'s embossed at more or less regular intervals on the outside half of the border which are raised and depressed on the surface of the original metal sheet in alternating fashion;

Predetermining the outer dimensions of the original metal sheet by taking into account the following: 1) the width of the border extending around the periphery of the embossed design, which includes the multiple markers on the outer half thereof, and 2) the height of the side walls that will need to be extended up from the bottom surface to create a box-like structure that can be used as the casting mold to create the new molds;

Creating a first mold that contains a negative image of the artwork thereon and a second mold that contains a positive image of the artwork thereon;

Folding up all four sides of the original metal sheet along a fold line that extends outside the border, to form a first box structure with all four side walls extended up, with the positive image of the embossed design facing up on the bottom surface thereof, wherein the four side walls are extended up in the same direction;

Applying a release agent such as comprising silicon or wax onto the inside surface of the first box structure, such as by spraying the agent onto the surface, and then brushing the agent across the surface, and then lightly spraying the agent onto the surface a second time;

Mixing resin and hardener to form a resin mixture wherein the hardener provides short pot life and fast curing times;

Mixing epoxy resin and hardener to form a mixture that has a viscosity of less than 8000 cps which is thin enough to help avoid forming bubbles;

Using an epoxy resin that has significant compression and tensile strength and a shore hardness of at least 70D;

Pouring the resin mixture into the first box structure and doing so slowly and into a single location to help avoid forming bubbles;

Allowing the resin mixture to set and cure for a predetermined time and allowing the resin mixture to sufficiently harden to form the first mold;

After the first mold is completed, folding all four side walls of the first box structure in the opposite direction to form a second box structure, with all four side walls extended in the opposite direction, wherein the negative image of the embossed design faces up on the bottom surface thereof, i.e., in the same direction as the four side walls;

Removing the first mold from the first box structure;

Applying a release agent such as comprising silicon or wax onto the inside surface of the second box structure, such as spraying the agent onto the surface, and then brushing the agent across the surface, and then lightly spraying the agent onto the surface a second time;

Mixing resin and hardener to form a resin mixture wherein the hardener provides short pot life and fast curing times;

Mixing epoxy resin and hardener to form a mixture that has a viscosity of less than 8000 cps which is thin enough to help avoid forming bubbles;

Using an epoxy resin that has significant compression and tensile strength and a shore hardness of at least 70D;

Pouring the resin mixture into the second box structure and doing so slowly and into a single location to help avoid forming bubbles;

Allowing the resin mixture to set and cure for a predetermined time and allowing the resin mixture to sufficiently harden to form the second mold;

Removing the second mold from the second box structure; Using a hydraulic or arbor press with a capacity of at least 2 tons; Predetermining the amount of pressure that should be applied using the press to deform the new metal sheet and form the artwork thereon;

Using more pressure with the press in the second step than in the first step; Placing a compressible pad made of rubber onto a support plate, followed by a new metal sheet, and then the first mold, with the negative image of artwork facing down;

Using a compressible pad that has a hardness of equal to or more than 70A; Using a compressible pad in the first press step having a hardness of less than 60A and using a compressible pad in the second press step having a hardness of at least 70A;

Placing an upper press plate on top of the first mold;

Applying pressure with the press to compress the new metal sheet between the first mold and the compressible pad and thereby deform the new metal sheet and transfer the artwork image from the first mold onto the new metal sheet;

Using the first mold with the negative image of the artwork first, followed by using the second mold with the positive image of the artwork second;

After the image of the embossed design has been transferred onto the new metal sheet using the first mold, removing the first mold and new metal sheet from the press;

Positioning the second mold onto the opposite side of the new metal sheet, with the positive image of the embossed design on the second mold facing the negative image of the embossed design that has been formed on the new metal sheet;

Aligning the negative image formed on the new metal sheet with the positive image on the second mold;

Using the multiple markers that have been formed on the new metal sheet and the multiple markers that have been formed on second mold to self-center and align the new metal sheet onto the second mold, which can be done by causing the markers to mate with each other and causing the negative image formed on the new metal sheet to be aligned with the positive image on the second mold;

Using fingers to ensure that the markers formed on the new metal sheet are positioned properly relative to the markers on the second mold, and hand positioning the new metal sheet relative to the second mold using the markers to help align and self-center the negative image on the new metal sheet with the positive image on the second mold;

Placing the second mold onto the compressible pad, with the new metal sheet positioned underneath, wherein the positive image of the embossed design on the second mold faces down, and the negative image of the embossed design on the new metal sheet faces up;

Using a compressible pad that has a hardness of equal to or more than 70A;

Placing an upper press plate on top of the second mold;

Applying pressure with the press to compress the new metal sheet between the second mold and the compressible pad and thereby deform the new metal sheet and transfer more of the artwork details from the second mold and onto the new metal sheet;

Removing the finished new metal sheet from the press;

Adding color to the surface of the new metal sheet for added visual effects; and

Securing the new metal sheet onto a frame/mat board with the frame/mat board covering the multiple markers on the border.

### BRIEF DESCRIPTION OF THE DRAWINGS

FIG. 1 is a plan view of the original metal sheet with the embossed design in the center, showing the fold lines for creating the box-like structures, and the multiple markers or X's formed around a border extending around the periphery of the embossed design;

FIG. 2 is a section view of the original metal sheet with the embossed design in the center, showing the side walls folded up along the fold lines to create the first box structure, with the positive image of the embossed design facing up;

FIG. 3 is a perspective view of a box-like structure created by folding up the edges of the original metal sheet to create four side walls with the embossed design situated on the bottom surface, thus forming a five-sided container with the top open that serves as the casting mold for creating the new molds, into which the liquid resin mixture can be poured;

FIG. 4 is a section view of the first box structure created by folding up the four side walls of the original metal sheet, such that the positive image of the embossed design faces up, in the same direction as the four side walls, wherein the liquid resin has been poured therein;

FIG. 5 is a section view of the first mold created by pouring the resin mixture into the first box structure, with the negative image of the embossed design facing down;

FIG. 6 is a section view of the first box structure being converted into the second box structure, by folding the four side walls in the opposite direction, such that the negative image of the embossed design on the bottom surface thereof faces down, in the same direction as the side walls;

FIG. 7 is a section view of the second box structure created by folding up the four side walls in the opposite direction, wherein the second box structure is shown flipped over (relative to the view shown in FIG. 6), such that the negative image of the embossed design faces up, wherein the liquid resin has been poured therein;

FIG. 8 is a section view of the second mold created by pouring the resin mixture into the second box structure, with the positive image of the embossed design facing down;

FIG. 9 is a side view showing layers stacked on top of the press during the first press step, with the new metal sheet positioned between the first mold and the compressible pad, wherein the first mold has a negative image of the embossed design facing down; and

FIG. 10 is a side view showing layers stacked on top of the press during the second press step, with the new metal sheet that has been deformed by the first press step positioned between the second mold and the compressible pad, wherein the second mold has a positive image of the embossed design facing down, and the new metal sheet has a negative image of the embossed design facing up, wherein the positive and negative images are aligned together using the multiple markers that have been formed on the new metal sheet and the second mold.

### DETAILED DESCRIPTION OF THE INVENTION

The invention will now be described in detail in conjunction with the attached drawings.

The first step in the process comprises creating the original artwork on the original metal sheet 1 in the form of an embossed design 3. Various types of hand tools or utensils can be used to create the original artwork, including sharp points, styluses, pens, dull points, flat edges, a rounded ball, a rubber point, a silicon knob, etc. The artist can use these tools and work both sides of the sheet to create the necessary raised and depressed images, wherein skill is required to create different lines, shapes and patterns at different levels depending on the desired results. A foam pad is preferably positioned underneath the original metal sheet 1 to enable the metal sheet to be properly worked, deformed and embossed.

Alternatively, the artist can draw the original artwork on a piece of paper and transfer that image onto the original metal sheet by using hand tools or utensils. For example, the paper on which the original artwork is drawn (which becomes a template) can be taped directly onto the original metal sheet 1, wherein a tool can then be used to transfer and emboss the artwork image directly onto the original metal sheet 1 using the same techniques.

Many types of pliable metal, such as aluminum, brass or copper, etc., can be used to create the original metal sheet 1. The thickness and pliability of the original metal sheet 1 preferably enables it to be easily worked and embossed using hand tools or utensils. In aluminum, the preferred thickness is 36 gauge, or 0.005 inches, or 5 mil, which is sufficiently soft to enable the metal to be easily worked and deformed, but stiff enough to retain its shape and configuration, although thinner and thicker sheets, such as 38 gauge, can be used. The preferred thickness for other materials, such as brass or copper, etc., will depend on their stiffness, with the goal of finding the appropriate balance between softness for workability and rigidity for retention of the embossed shape.

Because the original metal sheet 1 will be folded to create a container that will serve as the casting mold for making the new molds, the present invention contemplates starting with an original metal sheet 1 that is larger than the size of the original artwork image, i.e., the embossed design 3. As seen in FIG. 1, the original metal sheet 1 is preferably square or rectangular in shape and comprises the embossed design 3 in the center, wherein the overall size of the sheet extends beyond the size of the embossed design 3 and the anticipated outline 7 of the frame or mat board upon which the finished artwork is to be mounted.

As shown in FIG. 1, an additional border 5 is preferably extended beyond the anticipated outline 7 of the frame/mat board, wherein the border 5 preferably extends outward to the eventual fold line 11, which represents the outer dimension of the mold to be created. The border 5 is preferably wide enough to include multiple markers 9 on the outside half thereof, that are preferably interspersed and spaced substantially evenly around the periphery of the embossed design 3, wherein they are preferably located within the outer half of border 5 to ensure that the markers 9 do not interfere with the finished presentation of the artwork. The markers 9 preferably comprise predetermined shapes, including X's or +'s, or any other shape that achieves the desired results, and are preferably raised (convex), or, in alternating fashion, depressed (concave) on the original metal sheet 1. Each marker 9 can be created with the same hand tools used to create the embossed design 3, wherein the raised markers are created by pressing the back side of the original metal sheet 1, and the depressed markers are created by pressing the front side. Preferably, there are enough markers around the periphery of the embossed design 3 to keep the mold properly aligned with the new metal sheet, as will be discussed.

There should be enough of a border 5 around the embossed design to enable the new metal sheet to be secured to the frame/mat board without interfering with the presentation of the artwork. Preferably, at least a half inch border 5 should be provided around the periphery of the embossed design 3, including a quarter inch border around the artwork image (beyond the dimensions of the frame/mat board opening 7) to secure the artwork to the frame/mat board, and an additional quarter inch provided upon which to locate the multiple markers 9.

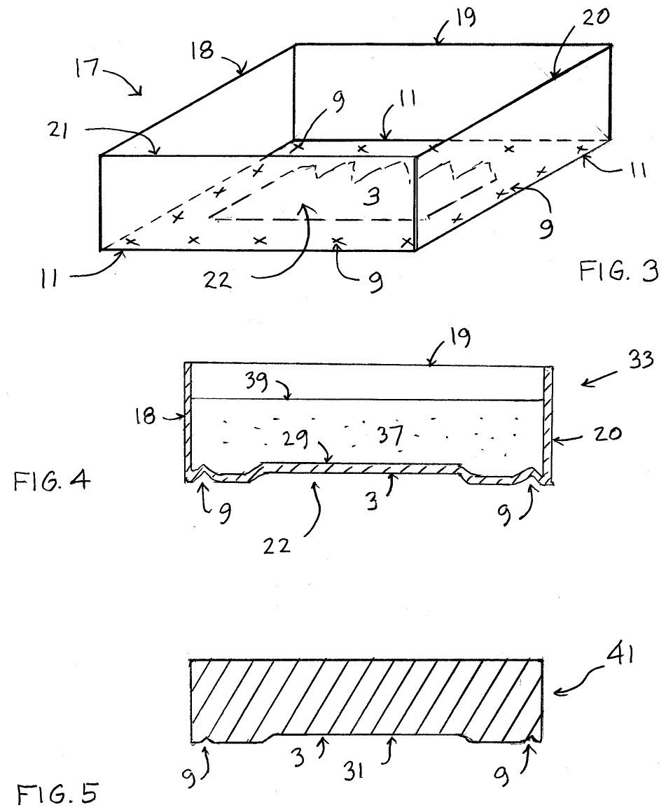

Preferably, the outer dimensions of the original metal sheet 1 are large enough and extend beyond the border 5 so that all four sides of extra material, 12, 13, 14, 15, can be folded up, such as at right angles, to form a box-like structure 17, as shown in FIG. 3. In this respect, the overall dimensions of the original metal sheet 1 are preferably at least two to six inches larger than the overall dimensions formed by fold lines 11. This allows each of the four side walls, 18, 19, 20 and 21, that will form the box-like structure 17, as shown in FIG. 3, to be folded along fold line 11 and extended up by as much as one to three inches above the bottom surface 22 of the box-like structure 17. FIG. 1 shows additional fold lines 23, 24, 25 indicating where original metal sheet 1 should be folded to create box-like structure 17.

As for the dimensions of the original metal sheet 1, if a new mold that is one inch thick is to be created, and for the extra material of the original metal sheet to be folded up along the sides to a sufficient height, there should be at least an extra inch and a half of material extended beyond the fold line 11 on each side. Here is an example: Assume that it is desirable that the original artwork will fit into a 5″×7″ opening of a frame or mat board. Thus, the border needed around the artwork for attaching the sheet onto the frame/mat board and for providing the markers 9 thereon would be at least a half inch beyond the opening on each side, all the way around, which would then extend the overall size of the original metal sheet to 6″×8″.

Then, to provide sufficient room to enable the sides to be folded up to form the box-like structure 17, there should be at least another one and a half inch of extra material extended beyond the fold line 11 on each side, thereby extending the overall size of the original metal sheet another three inches, i.e., to 9″×11.″ Again, the extra inch and a half of material on each side will enable the sides to be folded up to create the box-like structure 17, with four side walls, 18, 19, 20 and 21, that can be used as the casting mold for creating the new mold. Thus, in this example, the original metal sheet would be 9″×11,″ even though the embossed design 3 would fit inside the frame/mat board opening of 5″×7″.

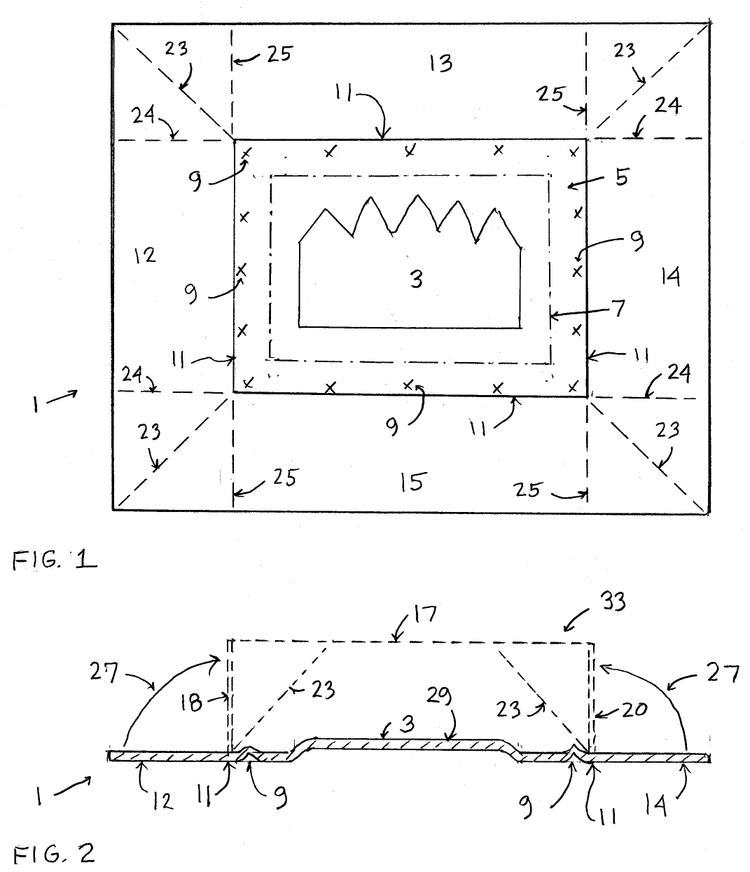

FIG. 2 shows how the four sides of extra material, 12, 13, 14 and 15, of the original metal sheet 1, can be folded up, see arrows 27, along fold line 11, to form the side walls, 18, 19, 20 and 21. This particular drawing is a cross section and thus it only shows sides 12 and 14 folded up to form side walls 18 and 20, but if the cross section was taken in a transverse direction, it would show sides 13 and 15 folded up to form side walls 19 and 21. FIG. 4 shows the positive image 29 of the embossed design facing up, in the same direction as the side walls, and as such, this represents the first box structure 33 that will be used to produce the first mold.

Note that “positive image” 29 refers to the raised side of the embossed design 3, while “negative image” 31 refers to the depressed side of the embossed design 3. Also note that FIG. 2 shows markers 9 raised in the same direction as the side walls, but it is contemplated that markers 9 can also be depressed in the opposite direction, such as in alternating fashion. Fold lines, such as 23, show the four side walls can be folded, i.e., at right angles (90 degrees) to form box-like structure 17.

FIG. 3 shows box-like structure 17 with embossed design 3 and markers 9 on the bottom surface 22, and side walls, 18, 19, 20 and 21, extended up at right angles along fold lines 11, but without regard to whether the positive image 29 or negative image 31 faces up. Nevertheless, if positive image 29 faces up, FIG. 3 would represent the first box structure 33 (which will be used to produce the first mold), but if negative image 31 faces up, FIG. 3 would represent the second box structure 34 (which will be used to produce the second mold).

FIG. 4 is a cross section of first box structure 33 that has been created by folding the four sides of extra material, 12, 13, 14 and 15, with the positive image 29 of the embossed design 3 on the bottom surface 22 facing up. It can be seen that this forms a five-sided container, with four side walls, 18, 19, 20 and 21, which are extended up from bottom surface 22, wherein this particular drawing is a cross section so it only shows two side walls 18 and 20 on opposing sides of bottom surface 22. Markers 9 are also shown raised up on the bottom surface 22, but they can also be depressed downward, such as in alternating fashion.

Once the embossed metal artwork has been created on the original metal sheet 1, the next step is to create two different molds that have the image of the artwork reproduced and embedded on them. In this respect, it has been found that it is desirable to create two molds—one to reproduce the positive image 29 of the artwork, and another to reproduce the negative image 31 of the artwork—such that one mold represents a positive image of the artwork that can be formed on one side of the new metal sheet, and the other mold represents a negative image of the same artwork that can be formed on the opposite side of the new metal sheet, wherein collectively they help to reproduce all the details in the original work of art.

To create an exact replica or near identical reproduction of the original artwork, the actual artwork created on the original metal sheet 1 is used as the casting mold to create the new molds. That is, the original metal sheet 1 on which the finished artwork is created is preferably folded up along the sides, into a box-like structure 17, and then, when the liquid resin (such epoxy or urethane) is poured into the box structure and allowed to cure, the end result will be the formation of a new mold that contains a near exact replica of the original embossed artwork on its surface. A separate casting mold in the shape of the original artwork will not be needed because the actual artwork is used as the casting mold, to ensure exact replication.

Each mold is preferably created as a slab that has a predetermined thickness—in most cases at least ½″ to 1″ thick, depending on the size of the mold—to ensure sufficient strength and resistance to compression and bending forces, which helps avoid breakage. The larger the mold, the thicker it should be. For example, a mold that is 2 inches square can be ½ inch thick, whereas, a mold that is 6 inches square should probably be at least ¾ inches thick or more.

In this respect, FIG. 4 shows the liquid resin mixture 37 that has already been poured into first box structure 33, to a level 39, to form the first mold 41, shown in FIG. 5. The liquid resin used to create each mold can be any known type that achieves the desired results, including those made of an epoxy or urethane, which has sufficient strength and compression properties, including resistance to bending, etc. The resin is preferably combined with a hardening catalyst or agent just before pouring, wherein after the mixture is poured, it can then be allowed to set and cured for a predetermined amount of time. Preferably, enough resin mixture is poured into each box structure so that each mold is sufficiently thick, such as at least ½ inch, depending on the size of the mold, and strong and resists bending and cracking, etc.

Preferably, the resin has significant compression and tensile strength and a shore hardness of at least 70D, although not necessarily so. Moreover, mixing the resin with the hardener preferably forms a mixture that has a viscosity of less than 8000 cps, wherein the mixture is preferably thin enough to avoid forming bubbles—the thinner the mixture the more the bubbles can escape while curing. The cure time can also affect the extent to which bubbles are allowed to escape—the longer the cure time the more the bubbles can escape, so a mixture with longer cure times may be desirable. It is also desirable to pour the resin mixture slowly and in a single location within the box structure to avoid creating more bubbles. Too many bubbles will cause the mold to lack strength and smoothness.

A release agent, such as one containing silicon or wax, is preferably applied to the inside surface of the box-like structure 17 before the liquid resin mixture is poured, so that the mold can easily be released from the box structure (the casting mold) once it has been formed. A spray or liquid release agent can be used for this purpose, and if it is sprayed, the agent should still be spread with a brush to ensure full surface coverage. A second follow up spray after the brushing can also be used.

Once the release agent has been applied, the first box structure 33 is placed with the bottom surface 22 on a level surface, with all four side walls extending up. Then, a resin, such as an epoxy or urethane, is mixed with a hardener and then poured slowly into the box structure and allowed to cure until it hardens. Care should be taken to pour the resin slowly into the box structure, beginning with the lowest point on the casting mold first, so as to avoid the creation of bubbles which can negatively affect the quality of the mold. If bubbles do form, care should be taken to remove the bubbles that may appear, such as by placing the mold in a vacuum chamber, to ensure that the mold cures properly to form a hard, physically strong, structure. Resins that have a short pot life and fast curing times enable making molds quickly, but tend to make it more difficult to avoid and remove bubbles before the material hardens.

Any of many different types of resins, including epoxies and urethanes, can be used, with or without filler, but ideally, the material can be easily poured and should have a viscosity of less than 8,000 cps—it should pour like a thin liquid syrup or honey, so that the material will be able to fill all the voids and gaps on the artwork image without creating bubbles. The resin material should have good physical properties, such as good compression and tensile strength, and good flexural modulus, to ensure that the finished mold will be hard and strong enough and will resist bending and will not break under pressure. For the strongest molds, a material with a relatively high shore hardness or durometer should be selected—ideally, the finished new mold should have a shore hardness of at least 70D, which is on the softer side, and preferably, it has a shore hardness of at least 80D or 90D or higher. At the same time, it should not be too brittle, to avoid cracking, and so that it can be reused multiple times without breaking.

FIG. 5 shows a cross section of the finished first mold 41 which has a negative image 31 of the embossed design 3 formed thereon (which is a mirror image of the positive image 29 on the first box structure 33) facing down. Note that because the first box structure 33 has a positive image 29 of the embossed design 3 facing up on the bottom surface 22 thereof, once the resin mixture hardens, and the first mold 41 is completed, it will form a rigid three dimensional negative image 31 of the embossed design 3 thereon. That is, the positive image 29 on the original metal sheet 1, as shown in FIG. 4, will be transferred to create a negative image 31 of the same design on the first mold 41, as shown in FIG. 5. Likewise, the raised markers 9 on the bottom surface 22 of the first box structure 33, as shown in FIG. 4, will form depressed markers 9 on the first mold 41, as shown in FIG. 5, and vice versa.

Preferably, the first mold 41 is created first, since the first box structure 33 can be laid flat (with the indentations facing up), which makes it easier to keep the first box structure 33 level while the resin mixture is being poured. Then the first mold 41 can be used as the supporting surface for creating the second mold 43, wherein, the shape of the negative image 31 on the first mold 41 can be used to support the positive image 29 of the second box structure 34, so that it can be maintained substantially level while pouring the resin. This helps to avoid sagging, which helps to form a uniformly thick slab.

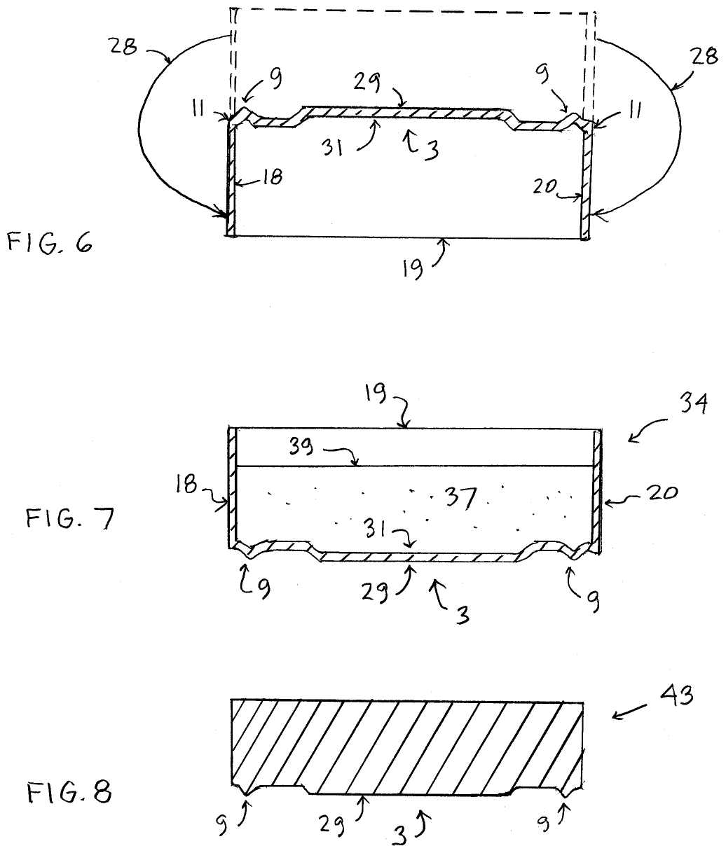

Once the first mold 41 is created, the original metal sheet 1 that was used to create the first mold 41 is preferably used as the casting mold to create the second mold 43, but this time, the same four side walls, 18, 19, 20 and 21, on the first box structure 33 are folded in the opposite direction, as shown in FIG. 6, by arrows 28, to create the second box structure 34, as shown in FIG. 7. That way, when the second box structure 34 is flipped over (from the position shown in FIG. 6 to the position shown in FIG. 7), the negative image 31 of the embossed design 3 will end up facing up, in the same direction as the side walls.

This can be done, for example, by carefully folding the four side walls of the first box structure 33 in the opposite direction, and peeling away the bottom surface thereof, thereby removing the original metal sheet 1 from the first mold 41. In this manner, the same original metal sheet 1 used to create the first box structure 33 can be used to create the second box structure 34, wherein the same four side walls are folded in the opposite direction, i.e., away from the positive image 29, such that the bottom surface 22 of the second box structure 34 will have the negative image 31 of the embossed design 3 thereon (rather than the positive image) with the four side walls, 18, 19, 29 and 21, extended up. Because the original metal sheet 1 is fairly pliable, it will be easy to fold the material along the same fold line 11, but while folding the metal sheet back and forth to create the box-like structures 17, care should be taken not to disturb the artwork that has been embossed and created on the surface of the original metal sheet 1.

Once the second box structure 34 has been created, the same release agent is preferably applied to the inside surface of the second box structure 34 before the resin mixture 37 is poured. Then, the same resin used to create the first mold 41 is preferably mixed with the hardening agent and poured into the second box structure 34, to form the second mold 43.

Preferably, the bottom surface 22 of the second box structure 34, with its negative image 31 of the embossed design 3 facing up, along with the four side walls, creates a five-sided open container into which the resin mixture can be poured to create the second mold 43.

FIG. 7 shows the resin mixture 37 that has already been poured into the second box structure 34, up to level 39, to create the second mold 43, as shown in FIG. 8, wherein, the negative image 31 on the second box structure 34 will be transferred to create a positive image 29 of the same design on the second mold 43. Preferably, enough resin is used to create the mold so that it is sufficiently thick, depending on the size of the mold, as discussed previously. After the resin has been poured, and the mixture is allowed to set/cure, the completed second mold 43 can be removed from the second box structure 34.

FIG. 8 shows a cross section of the finished second mold 43, which has a positive image 29 of the embossed design 3 formed thereon (which is a mirror image of the negative image 31 formed on the second box structure 34) facing down. Note that because the second box structure 34 has a negative image 31 of the embossed design 3 facing up on the bottom surface 22 thereof, once the resin mixture hardens, and the second mold 43 is completed, it will form a rigid three dimensional positive image 29 of the embossed design 3 thereon. Likewise, the depressed markers 9 on the bottom surface 22 of the second box structure 34, as shown in FIG. 7, will form raised markers 9 on the second mold 41, as shown in FIG. 8, and vice versa.

In creating the first 41 and second 43 molds, the markers 9 that were created on the original metal sheet 1 will be transferred onto the molds, so that they are positioned along the border 5 around the periphery of the embossed design 3. Preferably, on the original metal sheet 1, some markers 9 are raised on one side, and other markers, such as in alternating fashion, are raised on the opposite side. That way, when the markers are transferred onto the molds, there will be alternating raised and depressed markers positioned around the periphery of the embossed design 3 on the two molds.

Once both molds are finished, they should be allowed to cure and harden properly to reach maximum strength. Then, the molds will be ready to use in a press 50 to create additional replicas of metal sheets having nearly identical embossed artwork thereon. The box structure can then be discarded or kept for future castings.

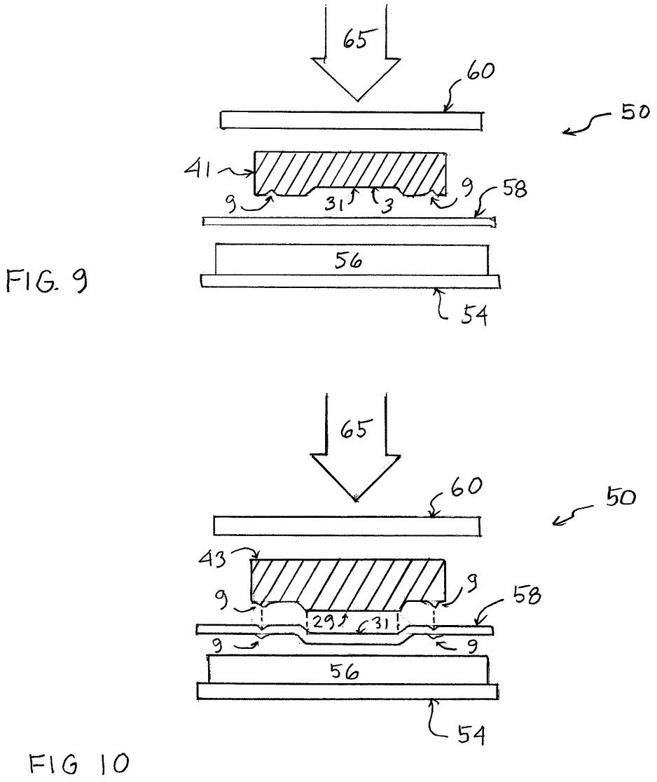

The two finished molds are then used in a press 50, diagrammatically shown in FIGS. 9 and 10, to transfer and replicate the embossed design 3 from the two molds 41 and 43 onto the new metal sheets 58. Preferably, the press 50 is hand operated, such as an arbor or hydraulic press, but it can be any conventional type, including mechanical or electrical presses, etc., capable of applying enough pressure to deform and create the necessary details on the new metal sheets 58.

Unlike conventional stamping methods, where positive and negative molds are used simultaneously, with the metal sheet sandwiched in between, the present method comprises using each mold in a separate press step, and compressing the new metal sheet against a compressible pad, wherein the pressure from the mold is applied against the compressible pad to create the artwork image on the new metal sheet. And because two molds are used, in two separate steps, the process preferably comprises using the first mold 41 in the first press step to create a negative image 31 of the artwork on the metal sheet, and then, flipping the metal sheet over, and aligning it with the second mold 43, and using the positive image on the second mold 43 to create additional details on the new metal sheet during the second press step.

The main reason that this is helpful, i.e., to use two molds—the positive and negative image molds—is because they help ensure that all of the details of the artwork can be transferred to and worked into the new metal sheet. By using two molds, and two steps, one with a positive image and one with a negative image, and flipping the new metal sheet over in between, the embossed design can be transferred from both the top and bottom sides, wherein, the metal can be worked gradually and it will be easier for the compressible pad to reach the deepest points on both sides, thereby helping to ensure that all the details, including all the high and low points, will be transferred to the new metal sheet from both sides.

It has also been found that it is desirable to use the first mold 41 first to help push the artwork design into the new metal sheet, thereby creating an initial outline of the embossed design on the new metal sheet. This is because when the artwork contains a central figure, and a flat surrounding area, compressing the new metal sheet under pressure can cause the surrounding areas to crimp and distort. It has been discovered that when high pressures are applied, and the central image is pushed outward, the rest of the sheet will want to stretch and pull to make room for the outward expansion of the central figure, wherein, the rest of the material can crimp and distort, thereby causing unwanted bends and ripples to form in the new metal sheet. The present method has been developed to avoid this from happening. In this respect, it has been found that it is desirable to use the first mold 41 first, followed by the second mold 43 second, which enables the outline of the protruding image of the artwork to be pushed into the new metal sheet gradually, by using the first mold, before forming more details of the artwork image using the second mold, thereby helping to work the metal sheet outward to form the indentations and deformations, i.e., in two steps instead of one, wherein this helps to simulate how the metal sheet is embossed using hand tools.

It has also been found that another way to help prevent this from happening is using the multiple markers 9 to keep the new metal sheet in place, so that it is not pulled or stretched in one direction or the other, as the second mold 41 is pressed against the new metal sheet 58, which can otherwise cause crimping and distortion to occur in the surrounding areas. The present invention contemplates that after the first press step, and forming the embossed design on the new metal sheet, the operator can hold the new metal sheet against the second mold 43, and cause the markers 9 that are on the new metal sheet to mate with the markers that are on the second mold 43, which causes them to self-align, so that the negative image on the new metal sheet will become and stay aligned with the positive image on the second mold 43. This helps ensure that all of the indentations created by the first press are aligned with the indentations on the second mold 43, wherein the two steps help transfer all of the details from the two molds, from both the top and bottom sides, to replicate the original artwork.

Another technique that can be used to offset this effect is to use a relatively soft compressible pad during the first press step, when using the first mold 41, to create the outline of the central figure on the new metal sheet, and then, using a relatively hard compressible pad during the second press step, when using the second mold 43, to create the additional details.

The present process will now be discussed in the order in which the steps are to be performed in the preferred embodiment.

The press 50 used to apply pressure can be any standard type, such as a hand operated hydraulic press or arbor press, preferably with at least a 10 ton capacity, although a 2 ton capacity or less could be sufficient. To avoid breaking the mold, it is desirable to use a support plate 54 at the bottom and another rigid plate 60 at the top, to help distribute all the forces that are applied by the press 50 equally throughout the surface of the molds. A concentrated force against the mold could potentially cause it to crack/break.

The first step is to place the compressible pad 56, such as made of thick rubber, onto the support plate 54. The compressible pad 56 is preferably a thick slab of rubber that has sufficient density, thickness (such as one inch thick or more) and flexibility (preferably with a shore hardness of about 70A or more) which enables the new metal sheet 58 to be deformed properly. For example, the compressible pad 56 should be hard enough to resist the pressure applied by the press 50 to deform the metal sheet, but soft enough to fill the cracks and crevices to replicate and create sufficient detail in the finished artwork.

In this respect, during these steps, it is desirable to use a compressible pad that is at least an inch thick and is relatively hard with a shore hardness of 70A to 90A, i.e., in both the first and second steps, which helps to keep the new metal sheet compressed and held in place as the second mold 43 pushes the embossed design into the new metal sheet, thereby helping to create the artwork image thereon. With a compressible pad that has a shore hardness within the desired range, it will push back against the mold, thus creating the necessary indentations, but it will be soft enough to transfer the necessary details onto the new metal sheet. If the pad is too soft, it will not provide enough resistance to transfer those details, and if the pad is too hard, it will resist the transfer of those same details.

In an alternate embodiment, in conjunction with this first press step, i.e., using the first mold 41, it may be desirable to use a compressible pad 56 that is slightly softer, such as one that has a shore hardness of less than 60A. This makes it easier for the outline of the embossed design to be pushed into the mold and onto the new metal sheet 58. However, a compressible pad with a shore hardness of more than 60A and preferably 70A or more should be used during the second press step, using the second mold 43, as will be discussed, to ensure more of the details are transferred properly.

Next, the new metal sheet 58 (onto which the artwork will be transferred) is positioned onto the compressible pad 56, and then, the first mold 41 is placed thereon with the negative image 31 of the artwork facing down. In this respect, virtually any type of metal, such as aluminum, brass or copper, etc., can be used for the new metal sheet 58, although the preferred material for the new metal sheet 58 is aluminum. The properties of the new metal sheet preferably enable it to be easily deformed, wherein the preferred thickness for aluminum is 36 or 38 gauge. The new metal sheet 58 is preferably larger than the size of the first mold 41, but not as large as the original metal sheet 1, so that it can be folded and wrapped partially around the first mold 41, as needed.

Next, an upper rigid plate 60 is placed on top of the first mold 41, wherein the upper rigid plate 60 is strong enough to resist bending and cracking and is preferably larger than the size of the first mold 41, and positioned between the first mold 41 and the press 50 to distribute the load evenly across the first mold 41 and thereby prevent the first mold 41 from cracking.

With the members stacked on top of each other in this manner, as shown in FIG. 9, the press 50 can be operated and used to apply downward pressure onto the upper rigid plate 60, which then applies downward pressure onto the first mold 41, as shown by arrow 65, which then applies downward pressure against the new metal sheet 58, by pressing it against the compressible pad 56, thereby helping to deform the new metal sheet and thereby form the embossed design images. The pressure applied onto the compressible pad 56 helps to transfer the artwork image from the first mold 41 onto the new metal sheet 58, as it is compressed.

With the new metal sheet 58 positioned between the compressible pad 56 and first mold 41, sufficient pressure is preferably applied onto the rigid upper plate 60, to compress and deform the new metal sheet 58 between the compressible pad 56 and the first mold 41 and thus transfer the embossed design 3 thereon. Because the negative image 31 on the first mold 41 faces down, when the press is operated, the new metal sheet 58 will be deformed upward, into the negative spaces formed by the first mold 41, wherein the negative image of the embossed design 3 will be transferred onto the new metal sheet 58.

Of course, the order and orientation of the various elements positioned on the press 50 can be reversed, with the first mold 41 positioned on the support plate 54, with the negative image of the embossed design 3 facing up, followed by placing the new metal sheet 58 on top of first mold 41, followed by the compressible pad 56, and then, the rigid upper plate 60 on top, without departing from the present invention.

It is helpful to use the first mold 41 first because it has a negative image 31 of the embossed design 3 formed thereon, wherein the embossed design 3 is indented into the first mold 41. Accordingly, the first press step helps to gradually create the outline of the negative image 31 onto the new metal sheet 58, and doing this in two steps instead of one reduces the potential for crimping and distorting, which could otherwise occur. Because the flat areas of the first mold 41 presses against the new metal sheet 58 first, this initial pressure helps to keep the new metal sheet in place. Moreover, the markers 9 on the periphery also engage the new metal sheet, which helps to hold the new metal sheet 58 in place, especially around the edges, i.e., where markers 9 are located, wherein, as the compressible pad 56 presses against the new metal sheet 58, and fills the indentation in the first mold 41, the image will form gradually, without creating unwanted crimping and distortion around the surrounding areas.

In this respect, it should be noted that sufficient pressure should be applied by the press 50 to cause the shape of the embossed design 3 to be formed onto the new metal sheet 58, while the new metal sheet 58 is held in place by the markers 9, although at this point, it is not necessary to apply enough pressure to transfer all the details from the first mold 41 onto the new metal sheet 58. And because the compressible pad 56 may not be able to reach the deepest part of the first mold 41, the invention contemplates using a second press step, using the second mold 43, to further create the necessary details.

Once most if not all of the embossed design 3 has been transferred onto the new metal sheet 58, pressure is released and the press 50 is raised, after which the first mold 41 and new metal sheet 58 are removed from the press 50, preferably together. Then, the second mold 43 is preferably positioned against the opposite side of the new metal sheet 58, i.e., opposite the first mold 41, wherein the four edges extending from the new metal sheet 58 are folded backward and wrapped around the second mold 43, thus releasing the new metal sheet 58 from the first mold 41, and enabling a better transfer of the positive image 29 on the second mold 43 into the negative image 31 formed on the new metal sheet 58, all the while keeping the embossed design 3 on the new metal sheet 58 and second mold 43 aligned together.

At this point, it is important to note that before the next press step is performed using the second mold 43, the negative image 31 of the embossed design 3 that has been formed on the new metal sheet 58 will need to be aligned properly with the positive image 29 of the embossed design 3 on the second mold 43, so that further transfer of the embossed design 3 onto the new metal sheet 58 can continue during the second press step, wherein the second mold 43 is used to deepen and enhance the details of the embossed design 3 onto the finished surface. In this respect, because two molds are used—one having a positive image 29 of the embossed design 3, and the other having a negative image 31—it will be important to align the negative and positive images, i.e., between the first and second press steps, to accurately transfer all the details from the second mold 43 onto the new metal sheet 58.

Accordingly, once the artist performs the first press step and creates the negative image 31 of the embossed design 3 on the new metal sheet 58, the artist preferably uses the markers 9 to self-align the negative image 31 on the new metal sheet 58 with the positive image 29 on the second mold 43, prior to the second press step. That is, the artist uses his or her fingers to cause the alternating raised and depressed markers 9 formed on the new metal sheet 58 to mate together with the alternating depressed and raised markers on the second mold 43, to help keep the new metal sheet 58 in position relative to the second mold 43, and so that the negative and positive images are aligned properly and don't accidentally drift apart.

Accordingly, the second mold 43 can be used to create additional details on the new metal sheet 58, and accentuate the deformations that were formed during the first press step, particularly in locations that were difficult to reach using the first press step, which helps ensure that any additional details found on the second mold 43 that did not transfer properly during the first press step will be properly transferred during the second press step. Greater pressure can also be applied during the second press step to create the necessary details, since the alignments of the markers and the positive and negative images will keep them aligned together.

The markers 9 preferably serve two purposes. First, because two molds are created and used, it is necessary to properly align the negative image 31 formed on the new metal sheet 58 with the positive image 29 on the second mold 43, before the second press step is performed, wherein the markers 9 are provided to help provide this alignment. That is, after using the first mold 41 to form the embossed design 3 on the new metal sheet 58 during the first press step, the new metal sheet 58 will have to be positioned accurately against the second mold 43 during the second press step, wherein these markers 9 help to position the new metal sheet 58 onto the second mold 43. This ensures that during both press steps, the pressure that is applied will work to create identical images on the new metal sheet 58, i.e., from both directions—from one side and then the other, to further enhance the details.

Second, these markers 9 help to self-center and keep the new metal sheet 58 positioned in place against the second mold 43, wherein they also help to prevent the new metal sheet 58 from being stretched or pulled too far in one direction or the other, or otherwise crimped or distorted. Preferably, the markers 9 are raised and depressed sufficiently to enable them to mate and self-align, wherein the markers 9 are preferably extended around the periphery of the embossed design, relative to the second mold 43, so that they hold the new metal sheet 58 in place, such that it stays un-crimped and undistorted through the second press step. In this respect, it should be noted that the markers 9 help to keep the new metal sheet 58 in place, and therefore, as the compressible pad 56 fills the indentation to form the artwork, and as the new metal sheet 58 is stretched and pulled into the indentation, the markers will hold the periphery of the new metal sheet 1 in place, so that it will not crimp and distort along the edges, even as pressure is increased. This allows the new metal sheet 1 to deform gradually into the indentation, as it stretches and expands to create the shape of the embossed design 3, which simulates using hand tools.

Once this alignment is completed, the artist preferably takes the second mold 43, along with the new metal sheet 58 that has been wrapped around the second mold 43, and positions them onto the compressible pad 56, with the positive image 29 on the second mold 43 facing down, against the negative image 31 of the embossed design on the new metal sheet 58 facing up. This effectively flips the new metal sheet 58 over, from how it was positioned during the first press step, and helps to cause the positive image of the second mold 44 to be pressed into the new metal sheet 58 to create additional details. In this second press step, it is desirable to use more pressure and a relatively hard compressible pad 56 such as one that is at least one inch thick and has a shore hardness of 70A or more to ensure proper transfer of all the details.

The reason it is important to use the second mold 43 after the first press step is because it helps to form the additional details that are on the second mold 43, and transfer them from the second mold 43 onto the new metal sheet 58, without crimping and distorting the surrounding areas. In this respect, the relative hardness of the compressible pad 56 during this step ensures that the details of the embossed design are transferred into the indentations.

FIG. 10 shows the complete setup, with the support plate 54 preferably positioned beneath the compressible pad 56 and the upper rigid plate 60 preferably positioned on top of the second mold 43 so that pressure can be applied and distributed onto the new metal sheet 58 without breaking the mold. Then with these members stacked on top of each other in this manner, the press 50 can be operated and used to compress the pieces and apply pressure from the second mold 43 and onto the compressible pad 56, to transfer the artwork image from the second mold onto the new metal sheet 58.

This two-step process helps to gradually push the extension and expansion of the new metal sheet 58 to form the indentations, similar to the way hand tools can be used to gradually emboss the metal sheet, by working it over and over, from both sides of the sheet, so that it does not crimp and distort the surrounding areas of the artwork.

Additional work using hand tools can be provided on the surface of the new metal sheet 58, if desired, such as to add additional texture and detail, such as those that are too small for the mold to transfer using the above steps. Coloring and accents can also be added to the surface of the new metal sheet 58 to create various effects, i.e., copper can be burnished and colored, etc.

Although the markers are helpful in aligning the new metal sheet 58 with the new molds, particularly during the second step (after the markers are formed on the new metal sheet), alternative means of aligning the new metal sheet can be used. For example, sophisticated manufacturing equipment, including presses that have grooves and orientation markers on them, can be used, wherein the new metal sheet can be positioned in the proper location relative to the new mold.

Other alternate ways of producing new molds that replicate the original artwork are also contemplated. For example, the artwork can be scanned and a 3D printing technique can be used to create the new molds. In this respect, a first mold can be produced that replicates the negative image formed on the original metal sheet, and a second mold can be produced that replicates the positive image formed on the original metal sheet. The goal is to produce molds that accurately replicate the images and shapes, including the details, of the artwork embossed on the original metal sheet.

What is claimed is:

1. A method of replicating embossed metal artwork comprising:
creating an embossed design on a first metal sheet comprising a negative image of the embossed design on a first side and a positive image of the embossed design on a second side;
creating a first mold by transferring said negative image of the embossed design from said first metal sheet onto said first mold;
creating a second mold by transferring said positive image of the embossed design from said first metal sheet onto said second mold;
pressing said first mold onto a new metal sheet to transfer said negative image of the embossed design from said first mold onto said new metal sheet; and
pressing said second mold onto said new metal sheet to transfer said positive image of the embossed design from said second mold onto said new metal sheet.

2. The method of claim 1, wherein the method comprises creating multiple markers on said first metal sheet around the periphery of the embossed design, and transferring said multiple markers from said first metal sheet onto said first and second molds.

3. The method of claim 1, wherein the step of creating the first mold comprises:
folding four sides of said first metal sheet to form four side walls of a first box structure, with the positive image of the embossed design facing up;
applying a release agent on an inside surface of said first box structure;
pouring a resin mixture into said first box structure and allowing said resin mixture to harden; and
removing said first mold from said first box structure, wherein said first mold has the negative image of the embossed design formed thereon.

4. The method of claim 3, wherein creating the second mold comprises:
folding said four sides of said first metal sheet in an opposite direction to form four side walls of a second box structure, with the negative image of the embossed design facing up;
applying a release agent on an inside surface of said second box structure;
pouring a resin mixture into said second box structure and allowing said resin mixture to harden; and
removing said second mold from said second box structure, wherein said second mold has the positive image of the embossed design formed thereon.

5. The method of claim 2, wherein pressing said first mold onto said new metal sheet comprises:
positioning a compressible pad within a press;
positioning said new metal sheet on top of said compressible pad;
positioning said first mold on top of said new metal sheet, with the negative image of the embossed design on said first mold facing down against said new metal sheet;
compressing said new metal sheet between said compressible pad and said first mold; and
deforming said new metal sheet and transferring said negative image of the embossed design and said multiple markers onto said new metal sheet.

6. The method of claim 5, wherein pressing said second mold onto said new metal sheet comprises:
removing said new metal sheet from said press;
aligning the multiple markers that are formed on said second mold with multiple markers that are formed on said new metal sheet, to help align said positive image on said second mold with said negative image formed on said new metal sheet;
positioning said second mold against said new metal sheet with the positive image of the embossed design positioned against said negative image of said embossed design formed on said new metal sheet;
positioning said new metal sheet onto said compressible pad with a first side of said new metal sheet against said compressible pad;
compressing said new metal sheet between said compressible pad and said second mold; and
deforming said new metal sheet and transferring said positive image of the embossed design onto said new metal sheet.

7. The method of claim 6, further comprising placing a rigid plate on top of said first mold before applying pressure with said press to deform said new metal sheet, and placing a rigid plate on top of said second mold before applying pressure with said press to deform said new metal sheet.

8. A method of replicating embossed metal artwork comprising:
creating an embossed design on a first metal sheet, with a negative image of the embossed design formed on a first side of said first metal sheet, and a positive image of the embossed design formed on a second side of said first metal sheet, wherein the embossed design comprises multiple markers formed around a periphery thereof;
forming said negative image of the embossed design on a first mold using said first side of said first metal sheet, wherein said first mold has said negative image of the embossed design and said multiple markers formed thereon;
forming said positive image of the embossed design on a second mold using said second side of said first metal sheet, wherein said second mold has said positive image of the embossed design and said multiple markers formed thereon;
pressing said first mold onto a first side of a new metal sheet to transfer said negative image of the embossed design and said markers onto said new metal sheet; and
pressing said second mold onto a second side of said new metal sheet to transfer said positive image of the embossed design onto said new metal sheet.

9. The method of claim 8, comprising folding four sides of said first metal sheet to form a first box structure, wherein the positive image of the embossed design is facing up, and pouring a resin mixture into said first box structure to form said first mold, wherein said first mold has said positive image of said embossed design formed thereon, along with said multiple markers formed around a periphery of the embossed design.

10. The method of claim 8, comprising folding four sides of said first metal sheet to form a second box structure, wherein the negative image of the embossed design is facing up, and pouring a resin mixture into said second box structure to form said second mold, wherein said second mold has said negative image of said embossed design formed thereon, along with said multiple markers formed around a periphery of the embossed design.

11. The method of claim 8, wherein pressing said first mold onto said new metal sheet comprises:
positioning a compressible pad adjacent said new metal sheet;
positioning said first mold with said negative image facing against said first side of said new metal sheet;
applying pressure with a press and causing said first mold to deform said new metal sheet; and
transferring said negative image of the embossed design and said multiple markers onto said new metal sheet.

12. The method of claim 11, wherein pressing said second mold onto said new metal sheet comprises:
positioning a compressible pad adjacent said new metal sheet;
positioning said second mold with said positive image facing against said second side of said new metal sheet;
applying pressure with a press and causing said first mold to deform said new metal sheet; and
transferring said positive image of the embossed design onto said new metal sheet.

13. The method of claim 12, wherein pressing said second mold onto said new metal sheet further comprises:
removing said new metal sheet from said first mold; and
lining up said multiple markers formed on said second mold with said multiple markers formed on said new metal sheet, to align said positive image formed on said second mold with said negative image formed on said new metal sheet.

14. A replica created on a new metal sheet from an embossed design created on a first metal sheet, comprising the following steps:
transferring a negative image of the embossed design from a first side of said first metal sheet onto a first mold;
transferring a positive image of the embossed design from a second side of said first metal sheet onto a second mold;
transferring said negative image of the embossed design from said first mold onto a first side of said new metal sheet; and
transferring said positive image of the embossed design from said second mold onto a second side of said new metal sheet.

15. The replica of claim 14, created using these additional steps:
creating multiple markers on said first metal sheet which are used to create multiple markers on said first and second molds;
creating said first mold by folding four sides of said first metal sheet to form a first box structure, wherein the positive image of the embossed design faces up; and
pouring a resin into said first box structure to form said first mold, wherein said first mold has the negative image of said embossed design and said multiple markers formed thereon.

16. The replica of claim 14, created using these additional steps:
creating multiple markers on said first metal sheet which are used to create multiple markers on said first and second molds;
creating said second mold by folding four sides of said first metal sheet to form a second box structure, wherein the negative image of the embossed design faces up; and
pouring a resin into said second box structure to form said second mold, wherein said second mold has the positive image of said embossed design and said multiple markers formed thereon.

17. The replica of claim 14, created using the following additional steps:
positioning said new metal sheet onto a compressible pad;
positioning said first mold onto said new metal sheet, with said negative image on said first mold facing against said first side of said new metal sheet;
applying pressure with a press and causing said first mold to deform said new metal sheet; and
forming said negative image of the embossed design and said multiple markers onto said new metal sheet.

18. The replica of claim 17, created using the following additional steps:
removing said new metal sheet from said first mold;
lining up said multiple markers formed on said second mold with said multiple markers formed on said new metal sheet and using said multiple markers to align said positive image formed on said second mold with said negative image formed on said new metal sheet;
positioning said second mold onto said new metal sheet, with said negative image on said first mold facing against said first side of said new metal sheet, and positioning said new metal sheet adjacent said compressible pad;
compressing said new metal sheet between said second mold and said compressible pad; and
deforming said new metal sheet and transferring said positive image of the embossed design onto said new metal sheet.
